(19) United States
(12) Patent Application Publication
(10) Pub. No.: US 2011/0109415 A1
(43) Pub. Date: May 12, 2011

(54) INDUCTOR STRUCTURE

(76) Inventors: Jenq-Gong Duh, Hsinchu City (TW); Yuan-Tai Lai, Hsinchu City (TW)

(21) Appl. No.: 12/617,474

(22) Filed: Nov. 12, 2009

(51) Int. Cl. H01F 5/00

(52) U.S. Cl. 336/200

(57) ABSTRACT

The present invention discloses an improved inductor structure, which applies to the semiconductor field, particularly to a system-on-chip, and which comprises a substrate, a first conductive patterned film, and a first insulating layer formed between the substrate and the first conductive patterned film. The substrate has a base and an accommodation portion formed in the base. A magnetic material is filled into the accommodation portion to form a magnetic region. The accommodation portion is fabricated via etching the base or drilling a through-hole in the base. A plurality of conductive wires is arranged in a spiral way to form the first conductive patterned film. A protective layer covers the surface of the first conductive patterned film and isolates the contact of the first conductive patterned film and moisture.

### FIELD OF THE INVENTION

The present invention relates to an improved inductor structure, particularly to an improved inductor structure installed on a special substrate and applied to the semiconductor field.

### BACKGROUND OF THE INVENTION

With the progress of the semiconductor technology, most of circuit systems now can be fabricated into a single chip, i.e. the so-called system-on-chip or SOC for short. A system-on-chip usually has oscillation circuits and thus needs capacitors and inductors. For a capacitor or an inductor, the stored energy is proportional to the area of the element. Thus, an inductor having higher inductance needs a greater area. An U.S. Pat. No. 6,600,403 disclosed a planar inductor, wherein a coil is helically formed on a carrier to function as an induction loop. This prior art uses the spiral structure to increase the cross-section area of the equivalent conductor. For achieving a higher inductance, it is necessary to increase the coil length and the winding area. However, a greater winding area in the chip not only reduces the space available to other transistors and the size of the chip but also increases the parasitic capacitance between the carrier and the coil. The higher parasitic capacitance prolongs the delay time of the electronic elements, and decreases the energy-storage efficiency of the planar inductor in a higher-frequency application.

U.S. Pat. No. 7,262,680 and No. 7,173,508 disclosed a vertically-stacked inductor having multiple conductive layers, wherein each conductive layer is arranged by a coil which is spiraled up to form an inductor with multiple conductive layers vertically-stacked, whereby the area of the induced magnetic field is increased and a greater inductance is generated. The vertically-stacked structure does not occupy a too large area of the system-on-chip. Although most elements directly attach to the substrate in a system-on-chip, this prior-art inductor structure does not influence the size of the system-on-chip too much. However, when the area of the induced magnetic field is increased, additional parasitic capacitance is still generated, which inevitably decreases the energy-storage efficiency of the inductor and prolongs the delay time of the circuits.

### SUMMARY OF THE INVENTION

The primary objective of the present invention is to provide a reduction of module thickness, which can use the same area to achieve greater inductance without occupying additional space of a system-on-chip and raising parasitic capacitance, wherefore the present invention is exempt from decreasing the energy-storage efficiency of the inductor and increasing the delay time of the circuit.

To achieve the abovementioned objective, the present invention proposes an improved inductor structure, which applies to the semiconductor field, particularly to a system-on-chip, and which comprises a substrate, a first conductive patterned film, and a first insulating layer formed between the substrate and the first conductive patterned film. The substrate has a base and an accommodation portion formed on the base. A magnetic material is filled into the accommodation portion to form a magnetic region. The accommodation portion is fabricated via etching the base or drilling the base.

As mentioned above, the conventional technology increases the area of elements or vertically stacks the coils to increase the inductance. However, the present invention uses the characteristic of the electromagnetism of the magnetic region to enhance the mutual induction between the substrate and the first conductive patterned film. Therefore, the present invention can increase the inductance without occupying additional space of the system-on-chip.

### BRIEF DESCRIPTION OF THE DRAWINGS

FIG. 1 is a diagram schematically showing a spiral conductive patterned film according to a preferred embodiment of the present invention;

FIG. 2 is a sectional view schematically showing an improved inductor structure according to the preferred embodiment of the present invention;

FIG. 3 is a sectional view schematically showing an improved inductor structure according to another embodiment of the present invention;

FIG. 4 is a diagram schematically showing an improved inductor structure having a multi-layer structure according to the preferred embodiment of the present invention;

FIG. 5 is a sectional view schematically showing an improved inductor structure having a magnetic axis according to still another embodiment of the present invention; and

FIG. 6 is a sectional view schematically showing an improved inductor structure having multi-layer conductive wires according to still another embodiment of the present invention.

### DETAILED DESCRIPTION OF THE PREFERRED EMBODIMENTS

Below, the technical contents of the present invention will be described in detail in cooperation with the drawings.

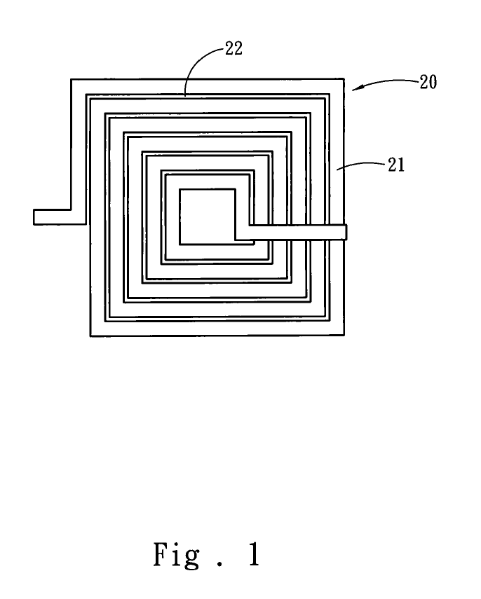

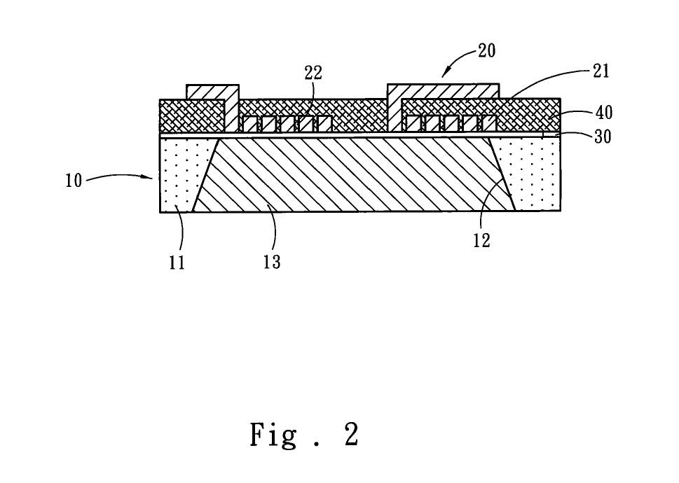

Refer to FIG. 1 and FIG. 2 respectively a schematic diagram of a conductive patterned film and a sectional view of an improved inductor structure according to a preferred embodiment of the present invention. The present invention proposes an improved inductor structure, which applies to the semiconductor field, particularly to a system-on-chip, and which comprises a substrate 10, a first conductive patterned film 20, a first insulating layer 30 formed between the substrate 10 and the first conductive patterned film 20, and a protective layer 40 covering on the surface of the first conductive patterned film 20. The substrate 10 has a base 11 and an accommodation portion 12 formed in the base 11. A magnetic material is filled into the accommodation portion 12 to form a magnetic region 13. The base 11 is made of a material selected from a group consisting of silicon, aluminum oxide and gallium arsenide; alternatively, the material of the base 11 is a combination of the abovementioned materials. The magnetic material is selected from a group consisting of ferrite, iron, cobalt, nickel and zinc; alternatively, the magnetic material is a combination of the abovementioned materials.

In the embodiment, the accommodation portion 12 is fabricated via drilling a through-hole on the base 11. After the circuit patterned conductive film is formed with a photolithographic technology and an etching technology, a through-hole is drilled on the other side of the substrate 10, which is opposite to the first conductive patterned film 20, to form the accommodation portion 12. Then, a magnetic material is filled into the accommodation portion 12 to form the magnetic region 13.

A plurality of conductive wires 21 is arranged in a spiral way to form the first conductive patterned film 20. The fist conductive patterned film 20 has a plurality of gaps 22. The protective layer 40 overlays on the first conductive patterned film 20 and connects with the first insulating layer 30 through the gaps 22. The protective layer 40 is made of polyimide and isolates the contact of the first conductive patterned film 20 and moisture. The protective layer 40 has superior thermal stability, cryogenic resistance, tensile strength and abrasion resistance. Therefore, the protective layer 40 can prevent that a minor warpage cracks the substrate 10 and that a collision abrades the substrate 10.

In the embodiment, the position and dimension of the magnetic region 13 are corresponding to the position and dimension of the first conductive patterned film 20. In the same embodiment, the accommodation portion 12 is located exactly below the first conductive patterned film 20 and corresponding to the position and dimension of the first conductive patterned film 20. The magnetic region 13 inside the accommodation portion 12 can enhance the mutual induction between the substrate 10 and the first conductive patterned film 20 and thus increase the inductance. Therefore, the present invention can achieve a higher inductance without occupying additional space of the system-on-chip.

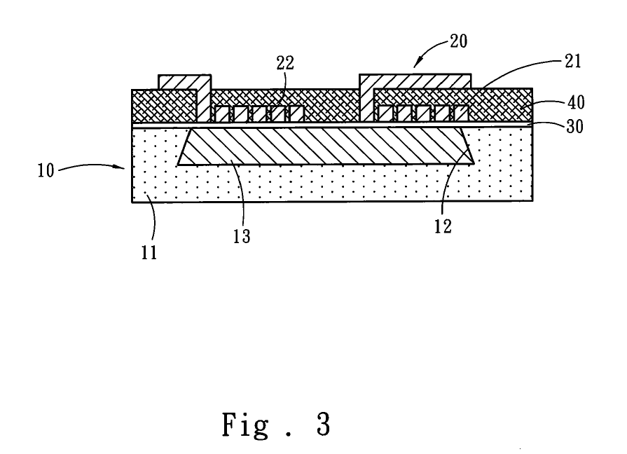

Refer to FIG. 3 for another embodiment. In this embodiment, a recess is beforehand fabricated in the base 11 to form the accommodation portion 12 via a drilling method or an etching method. Next, a magnetic material is filled into the accommodation portion 12 to form the magnetic region 13. Then, the first insulating layer 30 is fabricated to overlay the magnetic region 13 and the base 11. In this embodiment, the accommodation portion 12 does not penetrate the base 11 and has smaller dimension. Thus, less magnetic material is used, and the cost is reduced.

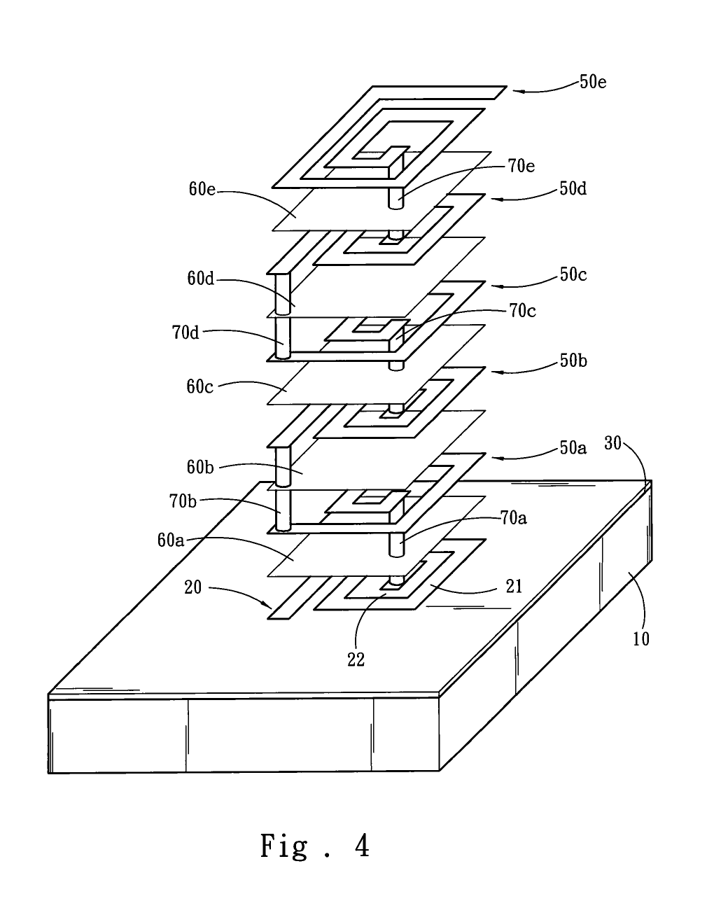

Refer to FIG. 4 for a multi-layer structure according to the present invention. In this embodiment, the improved inductor structure of the present invention further comprises a plurality of second conductive patterned films 50a, 50b, 50c, 50d and 50e, and a plurality second insulating layers 60a, 60b, 60c, 60d and 60e. The second conductive patterned films 50a, 50b, 50c, 50d and 50e and the second insulating layers 60a, 60b, 60c, 60d and 60e are stacked in an alternate way to form a multi-layer structure. A connection member 70a is arranged between the first conductive patterned film 20 and the second conductive patterned film 50a to electrically interconnect the first conductive patterned film 20 and the second conductive patterned film 50a. A plurality of connection members 70b, 70c, 70d and 70e are arranged among the second conductive patterned films 50b, 50c, 50d and 50e to electrically interconnect the second conductive patterned films 50b, 50c, 50d and 50e. The second insulating layer 60a is used to insulate the first conductive patterned film 20 from the second conductive patterned film 50a lest a current leakage occur therebetween and the inductance be reduced. The second insulating layers 60b, 60c, 60d and 60e are used to insulate the current leakage occurred among the second conductive patterned films 50a, 50b, 50c, 50d and 50e.

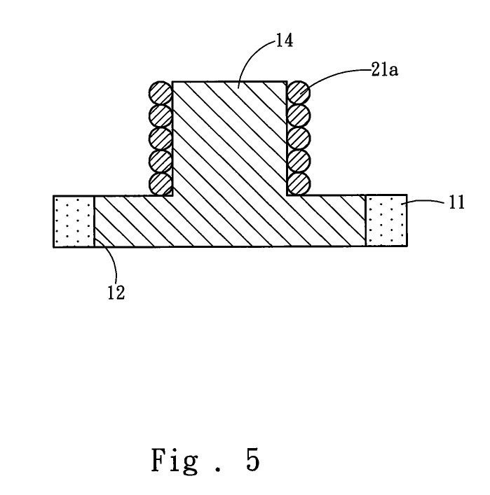

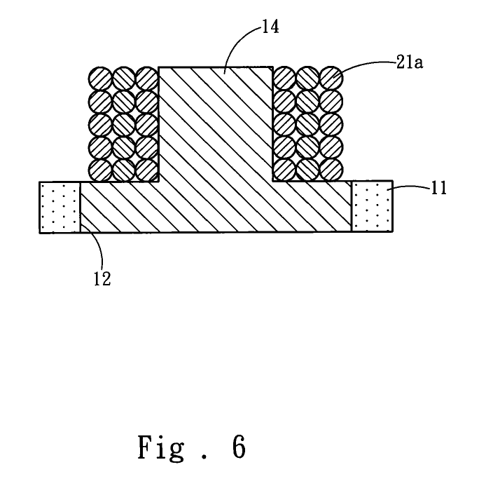

Refer to FIG. 5 for still another embodiment of the present invention. In addition to filling up the accommodation portion 12, the magnetic material may further extend out of the accommodation portion 12 and protrude to form a magnetic axis 14. A plurality of conductive wires 21a is wound around the magnetic axis 14 in the multi-layer way as shown in FIG. 6, and thus the inductance is increased.

In the conventional technologies, the inductance is increased via increasing the area of the elements or vertically stacking the elements. The improved inductor structure of the present invention uses the characteristic of the electromagnetism of the magnetic region formed on the substrate to enhance the mutual induction between the substrate and the first conductive patterned film and thus increase the inductance. In the present invention, the multi-layer structure of the second conductive patterned films and the second insulating layers can further increase the mutual induction. Therefore, the present invention can achieve a higher inductance without occupying additional space of the system-on-chip. As the conventional technologies usually have to increase the induction area of the inductor, the parasitic capacitance becomes very great. Because of the parasitic capacitor, the response speed of the electronic circuit is delayed in the conventional technologies. Nevertheless, the present invention can achieve greater inductance than the conventional inductor element without increasing the induction area. Therefore, the present invention will not increase the delay time caused by the parasitic capacitor.

The embodiments described above are only to exemplify the present invention but not to limit the scope of the present invention. Any equivalent modification or variation according to the spirit of the present invention is to be also included within the scope of the present invention.

What is claimed is:

1. An improved inductor structure comprising a substrate, a first conductive patterned film, and a first insulating layer formed between said substrate and said first conductive patterned film, wherein said substrate has a base and an accommodation portion formed in said base, and wherein a magnetic material is filled into said accommodation portion to form a magnetic region.

2. The improved inductor structure according to claim 1, wherein said accommodation portion is formed via etching said base.

3. The improved inductor structure according to claim 1, wherein said accommodation portion is formed via drilling a through-hole in said base.

4. The improved inductor structure according to claim 1, wherein said base is made of a material selected from a group consisting of silicon, aluminum oxide and gallium arsenide; alternatively, a material of said base is a combination of silicon, aluminum oxide and gallium arsenide.

5. The improved inductor structure according to claim 1, wherein said magnetic material is selected from a group consisting of ferrite, iron, cobalt, nickel and zinc; alternatively, said magnetic material is a combination of ferrite, iron, cobalt, nickel and zinc.

6. The improved inductor structure according to claim 1, wherein said magnetic region has a position and dimension corresponding to a position and dimension of said first conductive patterned film.

7. The improved inductor structure according to claim 1, wherein a plurality of conductive wires is arranged in a spiral way to form said first conductive patterned film.

8. The improved inductor structure according to claim 1 further comprising a protective layer covering the surface of said first conductive patterned film and isolating the contact of said first conductive patterned film and moisture.

9. The improved inductor structure according to claim 8, wherein said protective layer is made of polyimide.

10. The improved inductor structure according to claim 1 further comprising a plurality of second conductive patterned films and a plurality of second insulating layers; said second conductive patterned films and said second insulating layers are stacked in an alternate way to form a multi-layer structure.

11. The improved inductor structure according to claim 10, wherein a connection member is arranged between said first conductive patterned film and one said second conductive patterned film to electrically interconnect said first conductive patterned film and said second conductive patterned film; a plurality of connection members are arranged among said second conductive patterned films to electrically interconnect said second conductive patterned films.

12. The improved inductor structure according to claim 1, wherein said magnetic material protrudes from said accommodation portion to form a magnetic axis; a plurality of conductive wires is wound around said magnetic axis.
